(19) United States
(12) Patent Application Publication
(10) Pub. No.: US 2022/0167606 A1
(43) Pub. Date: Jun. 2, 2022

(54) METHOD FOR PLANTATION TREATMENT OF A PLANTATION FIELD

(71) Applicant: BASF Agro Trademarks GmbH, Ludwigshafen am Rein (DE)

(72) Inventors: Ole JANSSEN, Köln (DE); Matthias TEMPEL, Leverkusen (DE); Bjoern KIEPE, Köln (DE); Mirwaes WAHABZADA, Langenfeld (DE)

(21) Appl. No.: 17/599,082

(22) PCT Filed: Mar. 27, 2020
(86) PCT No.: PCT/EP2020/058860

§ 371 Date: Sep. 28, 2021

(30) Foreign Application Priority Data
Mar. 29, 2019 (EP) 19166297.2

(51) Int. Cl. A01M 7/00; G06V 10/70; G06V 20/10; G06V 20/64

(52) U.S. Cl. CPC A01M 7/0092; G06V 10/70; B64C 39/024; G06V 20/64; G06V 20/188

(57) ABSTRACT

A method for plantation treatment of a plantation field, the method, comprising: receiving (S10) a parametrization (10) for controlling a treatment device (200) by the treatment device (200) from a field manager system (100), wherein the parametrization (10) is dependent on offline field data (Doff) relating to expected conditions on the plantation field (300); taking (S20) an image (20) of a plantation of a plantation field (300); recognizing (S30) objects (30) on the taken image (20); determining (S40) at least one treatment product composition (40) optionally dependent or based on the determined parametrization (10), online field data and/or the recognized objects (30); determining (S50) a control signal (S) for controlling a treatment arrangement (270) of the treatment device (200) based on the determined parametrization (10), the recognized objects (30) and the chosen treatment product composition (40).

### FIELD OF INVENTION

The present invention relates to a method and a treatment device for plantation treatment of a plantation field, as well as a field manager system for such a treatment device and a treatment system.

### BACKGROUND OF THE INVENTION

The general background of this invention is the treatment of plantation in an agricultural field. The treatment of plantation, in particular the actual crops to be cultivated, also comprises the treatment of weed in the agricultural field, the treatment of the insects in the agricultural field as well as the treatment of pathogens in the agricultural field.

Agricultural machines or automated treatment devices, like smart sprayers, treat the weed, the insects and/or the pathogens in the agricultural field based on ecological and economical rules. In order to automatically detect and identify the different objects to be treated image recognition is used.

Modern agricultural machines get equipped with more and more sensors. Crop protection will be executed with smart sprayers, comprising predominantly of camera systems detecting plantation, in particular weeds, crop, insects and/or pathogens in real time. For deriving agronomical actionable actuator commands, e.g. triggering a spray nozzle or a weed robot for treating the plantation, further knowledge and input data is needed.

Especially difficult is to define when a pathogen or weed needs to be treated because of significant yield or quality impact on the crop or when the ecological impact or costs of the treatment product make it more appropriate not to treat at a specific area of the plantation field.

This missing link is giving a significant uncertainty to the farmers, which have to set a threshold for treating the plantation manually based on their gut feeling. This is typically done on field level, although many influence factors vary over the field.

### SUMMARY OF THE INVENTION

It would be advantageous to have an improved method for plantation treatment of a plantation field improving economic return of investment and improving an impact into the ecosystem.

The object of the present invention is solved with the subject matter of the independent claims, wherein further embodiments are incorporated in the dependent claims. It should be noted that the following described aspects and examples of the invention apply also for the method, the treatment device and the field manager system.

According to a first aspect a method for treatment or plantation treatment of a plantation field with a treatment product, the method, comprises:
receiving a parametrization for controlling a treatment device by the treatment device from a field manager system, wherein the parametrization is dependent or determined based on offline field data relating to expected conditions on the plantation field, and optionally receiving a treatment product composition expected to be used for treating the plantation further optionally dependent on the parametrization;
taking an image of a plantation of a plantation field;
recognizing object(s) on the taken image;
determining a treatment product composition optionally dependent or based on the determined parametrization, online field data and/or the recognized object(s);
determining a control signal for controlling the treatment device based on the received parametrization, the recognized object(s) and the chosen treatment product composition.

The plantation treatment, as used herein, preferably comprises protecting a crop, which is the cultivated plantation on the plantation field, destroying a weed that is not cultivated and may be harmful for the crop, in particular with a herbicide, killing insects on the crop and/or the weed, in particular with an insecticide, and destroying any pathogen on the crop and/or a disease, in particular with a fungicide, and regulating the growth of plants, in particular with a plant growth regulator. The term “insecticide”, as used herein, also encompasses nematicides, acaricides, and molluscicides. Furthermore, a safener may be used in combination with a herbicide.

In one embodiment taking an image includes taking an image in real time associated with a specific location on the plantation field to be treated or on the spot. This way the treatment can be finely adjusted to different situations on the field in quasi real time while the treatment is conducted. Additionally, treatment can be applied in a very targeted manner leading to more efficient and sustainable farming. In a preferred embodiment the treatment device comprises multiple image capture devices which are configured to take images of the plantation field as the treatment device traverses through the field. Each image captured in such a way may be associated with a location and as such provide a snapshot of the real time situation in the location of the plantation field to be treated. In order to enable a real time, location specific control of the treatment device, the parametrization received prior to treatment provides a way to accelerate situation specific control of the treatment device. Thus, decisions can be made on the fly while the treatment device traverses through the field and captures location specific images of the field locations to be treated.

Preferably the steps of taking an image, determining a treatment product composition, determining a control signal and optionally providing the control signal to a control unit to initiate treatment are executed in real time during passage of the treatment device through the field or during field treatment. Optionally the control signal may be provided to a control unit of the treatment device to initiate treatment of the plantation field and the treatment product composition or at least one active ingredient of the treatment product composition may be switched or changed during passage of the treatment device through the field or during field treatment. Hence the control signal may be configured to switch, adapt or change the treatment product composition or at least one active ingredient of the treatment product composition during passage of the treatment device through the field or during field treatment. The treatment product composition may be switched, adapted or changed based on the object recognition, which may include e.g. object species and object growth stage.

The term “object”, as used herein, comprises an object in the plantation field. The object may relate to an object to be treated by the treatment device, such as a plantation, like weed or crops, insects and/or pathogens. The object may be treated with a treatment product such as a crop protection product. The object may be associated with a location in the field to allow for location specific treatment.

Preferably, the control signal for controlling the treatment device may be determined based on the received parametrization, the recognized objects and online field data. In one embodiment online field data is collected in real time in particular by the plantation treatment device. Collecting online field data may include collecting sensor data from sensors attached to the treatment device or placed in the plantation field in particular on the fly or in real time as the treatment device passages the field. Collecting online field data may include soil data collected via soil sensory in the field associated with properties of the soil such as a current soil condition, e.g. nutrient content or soil moisture, and/or soil composition, or weather data collected via weather sensory placed in or in proximity to the field or attached to the treatment device and associated with a current weather condition or data collected via both soil and weather sensory.

The term “offline field data” as used herein refers to any data generated, collected, aggregated or processed before determination of the parametrization. The offline field data may be collected externally from the plantation treatment device. The offline field data may be data collected before the treatment device is being used. The offline field data may be data collected before the treatment is conducted in the field based on the received parametrization. Offline field data for instance includes weather data associated with expected weather conditions at the time of treatment, expected soil data associated with expected soil conditions, e.g. nutrient content, soil moisture, and/or soil composition, at the time of treatment, growth stage data associated with the growth stage of e.g. a weed or crop at the time of treatment, and/or disease data associated with the disease stage of a crop at the time of treatment. Offline field data may further include crop size, crop health or crop size in comparison to the size of other objects in the field, e.g. weed size.

The term “spatially resolved” as used herein refers to any information on a sub-field scale. Such resolution may be associated with more than one location coordinate on the plantation field or with a spatial grid of the plantation field having grid elements on a sub-field scale. In particular, the information on the plantation field may be associated with more than one location or grid element on the plantation field. Such spatial resolution on sub-field scale allows for more tailored and targeted treatment of the plantation field.

The term “condition on the plantation field” relates to any condition of the plantation field or environmental condition in the plantation field, which has impact on the treatment of the plantation. Such condition may be associated with the soil or weather condition. The soil condition may be specified by soil data relating to a current or expected condition of the soil. The weather condition may be associated with weather data relating to a current or expected condition of the weather. The growth condition may be associated with the growth stage of e.g. a crop or weed. The disease condition may be associated with the disease data relating to a current or expected condition of the disease.

The term “treatment device”, as used herein or also called control technology, may comprise chemical control technology. Chemical control technology preferably comprises at least one means for application of treatment products, particularly crop protection products like insecticides and/or herbicides and/or fungicides. Such means may include a treatment arrangement of one or more spray guns or spray nozzles arranged on an agricultural machine, drone or robot for maneuvering through the plantation field. In a preferred embodiment the treatment device comprises one or more spray gun(s) and associated image capture device(s). The image capture devices may be arranged such that the images are associated with the area to be treated by the one or more spray gun(s). The image capture devices may for instance be mounted such that an image in direction of travel of the treatment device is taken covering an area that is to be treated by the respective spray gun(s). Each image may be associated with a location and as such provide a snapshot of the real time situation in the plantation field prior to treatment. Hence the image capture devices may take images of specific locations of the plantation field as the treatment device traverses through the field and the control signal may be adapted accordingly based on the image taken of the area to be treated. The control signal may hence be adapted to the situation captured by the image at the time of treatment in a specific location of the field.

The term “recognizing”, as used herein, comprises the state of detecting an object, in other words knowing that at a certain location is an object but not what the object exactly is, and optionally the state of identifying an object, in other words knowing the type of object that has been detected, in particular the species of plantation, like crop or weed, insect and/or pathogen. Recognition may include determination of spatial parameters like crop size, crop health, crop size in comparison to e.g. weed size. Such determination may be done locally as the treatment device passes through the field. In particular, the recognition may be based on an image recognition and classification algorithm, such as a convolutional neural network or others known in the art. In particular, the recognition of an object is location specific depending on the location of the treatment device. This way treatment can be adapted to a local situation in the field in real-time.

The term “parametrization”, as used herein, relates to a set of parameters provided to a treatment device for controlling the treatment device treating the plantation. The parametrization for controlling the treatment device may be at least partially spatially resolved for the plantation field or at least partially location specific. Such spatial resolution or location specificity may be based on spatially resolved offline field data. Spatially resolved offline data may include spatially resolved historic or modelling data of the plantation field. Alternatively or additionally spatially resolved offline data may be based on remote sensing data for the plantation field or observation data detected at limited number of locations in the plantation field. Such observation data may include images detected in certain locations of the field e.g. via a mobile device, and optional outcomes derived via image analysis.

The parametrization may relate to a configuration file for the treatment device, which may be stored in memory of the treatment device and accessed by the control unit of the treatment device. In other words, the parametrization may be a logic e.g. a decision tree with one or more layers, which is used to determine a control signal for controlling the treatment device dependent on measurable input variables e.g. images taken and/or online field data. The parametrization may include one layer relating to an on/off decision and optionally a second layer relating to a composition of the treatment product expected to be used and further optionally a third layer relating to a dosage of the treatment product expected to be used. Out of these layers of parametrization the on/off decision, the composition of the treatment product and/or the dosage of the treatment product may spatially resolved or location specific for the plantation field. In such way a situational, real-time decision on treatment is based on real-time images and/or online field data collected while the treatment device passages the field. Providing a parametrization prior to the execution of treatment reduces the computing time and at the same time enables reliable determination of control signals for treatment. The parametrization or configuration file may include location specific parameters provided to the treatment device, which may be used to determine the control signal.

In one layer the parametrization for on/off decisions may include thresholds relating to a parameter(s) derived from the taken image and/or the object recognition. Such parameters may be derived from the image that is associated with the object(s) recognized and decisive for the treatment decision. In a preferred embodiment the parameter derived from the taken image and/or object recognition relates to an object coverage. Further parameters may be derived from online field data decisive for the treatment decision. Is the derived parameter e.g. below the threshold the decision is off or no treatment. Is the derived parameter e.g. above the threshold the decision is on or treatment. The parametrization may include a spatially resolved set of thresholds. In such way the control signal is determined based on the parametrization and the recognized objects. In the case of weed the derived parameter from the image and/or recognized weeds in the image may be based on a parameter signifying the weed coverage. Similarly in the case of a pathogen the derived parameter from the image and/or recognized pathogens in the image may be based on a parameter signifying the pathogen infestation. Further similarly in the case of a insects the derived parameter from the image and/or recognized insects in the image may be based on a parameter signifying the number of insects present in the image.

Preferably, the treatment device is provided with a parametrization or configuration file, based on which the treatment device controls the treatment arrangement. In a further embodiment determination of the configuration file or parametrization comprises a determination of a dosage level the treatment product is to be applied. The parametrization may hence include a further layer on dosage level of the treatment product. Such dosage level may relate to a derived parameter from the image and/or object recognition. Further parameters may be derived from online field data. In other words, based on the configuration file or parametrization the treatment device is controlled, as to which dose of the treatment product should be applied based on real-time parameters of the plantation field, such as images taken and/or online field data. In a preferred embodiment the parametrization includes variable or incremental dosage levels depending on one or more parameter(s) derived from the image and/or object recognition. In a further preferred embodiment determining a dosage level based on the recognized objects includes determining object species, object growth stages and/or object density. Here object density refers to the density of objects identified in a certain area. Object species, object growth stages and/or object density may be the parameters derived from the image and/or object recognition according to which the variable or incremental dosage level may be determined. The parametrization may include a spatially resolved set of dosage levels.

The term “dosage level” preferably refers to the amount of treatment product per area, for example one liter of treatment product per hectare, and can be preferably indicated as the amount of active ingredients (contained in the treatment product) per area. More preferably, the dosage level shall not exceed a upper threshold, wherein this upper threshold is determined by the maximum dosage level, which is legally admissible according the applicable regulatory laws and regulations, in relation to the corresponding active ingredients of the treatment product.

The parametrization may include a further layer on the treatment product composition expected to be used. In such a case the parametrization may be determined depending on an expected significant yield or quality impact on the crop, an ecological impact and/or costs of the treatment product composition. Therefore, based on the parametrization, the decision, if a field is treated or not and with which treatment product composition at which dosage level it should be treated is taken for the best possible result in regard of efficiency and/or efficacy. The parametrization may include a tank recipe for a treatment product tank system of the treatment device. In other words, the treatment product composition may signify the treatment product components provided in one or more tank(s) of the treatment device prior to conducting the treatment. Mixtures from one or more tank(s) forming the treatment product may be controlled on the fly depending on the determined composition of the treatment product. The treatment product composition may be determined based on the object recognition, which may include e.g. object species and/or object growth stage. Additionally or alternatively, the parametrization may include a spatially resolved set of treatment product compositions expected to be used. The term “efficiency” relates to balance of the amount of treatment product applied and the amount of treatment product needed to effectively treat the plantation in the plantation field. How efficiently a treatment is conducted depends on environmental factors such as weather and soil.

The term “efficacy” relates to the balance of positive and negative effects of a treatment product. In other words, efficacy relates to optimum of the dose of treatment product needed to effectively treat a specific plantation. The dose should not be so high that treatment product is wasted, which would also increase the costs and the negative impact on the environment, but is not so low that the treatment product is not effectively treated, which could lead to immunization of the plantation against the treatment product. Efficacy of a treatment product also depends on environmental factors such as weather and soil.

The term “treatment product”, as used herein, refers to products for plantation treatment such as herbicides, insecticides, fungicides, plant growth regulators, nutrition products and/or mixtures thereof. The treatment product may comprise different components—including different active ingredients—such as different herbicides, different fungicides, different insecticide, different nutrition products, different nutrients, as well as further components such as safeners (particularly used in combination with herbicides), adjuvants, fertilizers, co-formulants, stabilizers and/or mixtures thereof. The treatment product composition is a composition comprising one, or two, or more treatment products. Thus, there are different types of e.g. herbicides, insecticides and/or fungicides, respectively based on different active ingredient(s). Since the plantation to be protected by the treatment product preferably is a crop, the treatment product can be referred to as crop protection product. The treatment product composition may also comprise additional substances that are mixed to the treatment product, like for example water, in particular for diluting and/or thinning the treatment product, and/or a nutrient solution, in particular for enhancing the efficacy of the treatment product. Preferably, the nutrient solution is a nitrogen-containing solution, for example liquid urea ammonium nitrate (UAN).

The term “nutrition product”, as used herein, refers to any products which are beneficial for the plant nutrition and/or plant health, including but not limited to fertilizers, macronutrients and micronutrients.

While executing the described method or while executing treatment of the plantation field, based on the determined parametrization, for each location in the plantation field another treatment product composition can be the most promising. Preferably, a treatment product composition used for treating the plantation, insect and/or pathogen may be switched, adapted or changed to another treatment product composition. Thus, a plurality of different types of treatment product composition may be used for treating different locations in the plantation field.

In one embodiment determining the control signal includes generating a tank actuator signal and a treatment arrangement signal to control release of the determined treatment product composition. On determining or generating the control signal, a tank actuator signal may be generated that controls actuators of the treatment device to release the treatment product composition from a tank system. Additionally, on generating the control signal a treatment arrangement or nozzle signal may be generated that controls release of the treatment product composition, preferably at a defined dosage level, on the field.

In a further embodiment the treatment device includes a treatment arrangement with more than one nozzle, wherein the treatment arrangement signal triggers one or more nozzles separately. This way the decision based on e.g. thresholds to treat or not treat as specified in the parametrization may be taken on an individual nozzle basis.

In one embodiment the treatment device includes a tank system with more than one tanks. Individual tanks may comprise one or more active ingredients and/or additional components such as water or part(s) of a formulation. Such a system allows for switching or changing active ingredient or treatment product composition during treatment. The tanks may be equipped with a controllable actuator to release at least part of the tank content or a certain amount of tank content as e.g. required for the dosage level. The tank actuator signal may include actuator signals for individual tanks to control release from the individual tanks to form the treatment product composition. Hence the tank actuator signal may be derived from the determined treatment product composition.

Determining a treatment product composition may include determining the treatment product composition based on the taken image and/or online field data. Alternatively, determining a treatment product composition may include adjusting the treatment product composition provided via the parametrization based on the taken image and/or online field data.

Including a pre-determined parametrization into the treatment device control improves the decision making and hence the efficiency of the treatment and/or the efficacy of the treatment product. Thus, an improved method for plantation treatment of a plantation field improving economic return of investment and improving an impact into the ecosystem is provided.

In a preferred embodiment, the method comprises:
receiving the offline field data by the field manager system;
determining the parametrization of the treatment device dependent on the offline field data and optionally determining the at least one treatment product composition; and
providing the determined parametrization and optionally the determined treatment product composition to the treatment device.

Determining the parametrization needs relatively many resources. The treatment device generally has only a relatively low computational power, particularly when decision need to be computed in real-time during treatment. Thus, the calculation heavy processes are preferably done offline, externally from the treatment device. Additionally, the field manager system may be integrated in a cloud computing system. Such a system is almost always online and generally has a higher computational power than the treatment device internal control system.

Thus, the efficiency of the treatment and/or the efficacy of the treatment product can be improved. Thus, an improved method for plantation treatment of a plantation field improving economic return of investment and improving an impact into the ecosystem is provided.

In a one embodiment, the offline field data comprises local yield expectation data, resistance data relating to a likelihood of resistance of the plantation against a treatment product, expected weather data, expected plantation growth data, expected weed growth data, zone information data, relating to different zones of the plantation field e.g. as determined based on biomass, expected soil data and/or legal restriction data.

In a further embodiment, the expected weather data refers to data that reflects forecasted weather conditions. Based on such data the determination of the parametrization or a configuration file for the treatment arrangement for application is enhanced, since the efficacy impact on treatment products may be included into the activation decision and dosage. For instance, if a weather with high humidity is present, the decision may be taken to apply a treatment product since it is very effective in such conditions. The expected weather data may be spatially resolved to provide weather conditions in different zones or at different locations in the plantation field, where a treatment decision is to be made.

In a further embodiment, the expected weather data includes various parameters such as temperature, UV intensity, humidity, rain forecast, evaporation, dew. Based on such data the determination of the parametrization or a configuration file for the treatment arrangement for application is enhanced, since the efficacy impact on treatment products may be included into the activation decision and dosage. For instance, if high temperatures and high UV intensity are present, the dosage of the treatment product may be increased to compensate for faster evaporation. On the other hand, if e.g. temperatures and UV intensity are moderate metabolism of plants is more active and the dosage of the treatment product may be decreased.

In a further embodiment, the expected soil data, e.g. soil moisture data, soil nutrient content data or soil composition data, may be accessed from an external repository. Based on such data the determination of the parametrization or a configuration file for the treatment arrangement for application is enhanced, since the efficacy impact on treatment products may be included into the activation decision and dosage. For instance, if high soil moisture is present, the decision may be taken not to apply a treatment product due to sweeping effects. The expected soil data may be spatially resolved to provide soil moisture properties in different zones or at different locations in the plantation field, where a treatment decision is to be made.

In a further embodiment, at least part of the offline field data includes historic yield maps, historic satellite images and/or spatial distinctive crop growth models. In one example a performance map may be generated based on historic satellite image including e.g. images of the field at different points in a season for multiple seasons. Such performance maps allow to identify e.g. variations in fertility in the field by mapping zones which were more or less fertile over multiple seasons.

Preferably, the expected plantation growth data is determined dependent on the amount of water still available in the soil of the plantation field and/or expected weather data.

Thus, the efficiency of the treatment and/or the efficacy of the treatment product can be improved. Thus, an improved method for plantation treatment of a plantation field improving economic return of investment and improving an impact into the ecosystem is provided.

In a preferred embodiment, legal restriction data include a leaching risk, in particular into the ground water, and/or a field slope, in particular leading to surface drainage, and/or a need for buffer zones to sensitive zones.

Preferably, the legal restrictions prohibit the use of specific treatment products in specific conditions of the plantation field. Preferably, a border zone, extending around the border of the plantation field is a sensitive zone, for example because of their increased exposure to humans and their pets. Therefore, effective treatment products, which may have an increased negative impact on other organisms, may be prohibited in the sensitive zone itself and a buffer zone between the sensitive zone and the zone of application of the treatment product.

Thus, the efficiency of the treatment and/or the efficacy of the treatment product can be improved. Thus, an improved method for plantation treatment of a plantation field improving economic return of investment and improving an impact into the ecosystem is provided.

In a preferred embodiment, the method comprises:
determining the zone information data based on an existing zone map of the plantation field.

Preferably, the zone map comprises at least a border zone, a buffer zone and/or a sensitive zone.

The zone information preferably relates to the zone of the zone map, in which the image was taken and therefore, the plantation to be treated is located. The zone information for example comprises the information that the plantation to be treated is located in a border zone. A border zone is subjected to specific legal restrictions regarding treatment products. If the treatment product composition, which is determined for the specific zone violates the legal restrictions of the zone of the plantation, another treatment product has to be determined in order to treat the plantation.

Thus, it is possible to treat the plantations on the plantation field with different types of treatment product, which improves the economic return of investment and the impact into the ecosystem of the method.

Thus, the efficiency of the treatment and/or the efficacy of the treatment product can be improved. Thus, an improved method for plantation treatment of a plantation field improving economic return of investment and improving an impact into the ecosystem is provided.

In a preferred embodiment, the method comprises:
recognizing objects includes recognizing a plantation, preferably a type of plantation and/or a plantation size, an insect, preferably a type of insect and/or an insect size, and/or a pathogen, preferably a type of pathogen and/or a pathogen size.

Thus, the efficiency of the treatment and/or the efficacy of the treatment product can be improved. Thus, an improved method for plantation treatment of a plantation field improving economic return of investment and improving an impact into the ecosystem is provided.

In a preferred embodiment, the method comprises:
receiving online field data by the treatment device relating to current conditions on the plantation field; and
determining the control signal dependent on the determined parametrization, the chosen treatment product composition and the determined recognized objects and/or the determined online field data.

Thus, the efficiency of the treatment and/or the efficacy of the treatment product can be improved. Thus, an improved method for plantation treatment of a plantation field improving economic return of investment and improving an impact into the ecosystem is provided.

Determining online field data by the treatment device may include sensory mounted on the treatment device or placed in the field and received by the treatment device.

In a preferred embodiment, the method comprises:
the online field data relates to current weather data, current plantation growth data and/or current soil data, e.g soil moisture data.

In one embodiment, the current weather data is recorded on the fly or on the spot. Such current weather data may be generated by different types of weather sensors mounted on the treatment device or one or more weather station(s) placed in or near the field. Hence the current weather data may be measured during movement of the treatment device on the plantation field. Current weather data refers to data that reflects the weather conditions at the location in the plantation field a treatment decision is to be made. Weather sensors are for instance rain, UV or wind sensors.

In a further embodiment, the current weather data includes various parameters such as temperature, UV intensity, humidity, rain forecast, evaporation, dew. Based on such data the determination of a configuration of the treatment device for application is enhanced, since the efficacy impact on treatment products may be included into the activation decision and dosage. For instance if high temperatures and high UV intensity are present, the dosage of the treatment product may be increased to compensate for faster evaporation.

In a further embodiment, the online field data includes current soil data. Such data may be provided through soil sensors placed in the field or it may be accessed form e.g. a repository. In the latter case current soil data may be downloaded onto a storage medium of an agricultural machine including treatment gun(s). Based on such data the determination of a configuration of the treatment arrangement for application is enhanced, since the efficacy impact on treatment products may be included into the activation decision and dosage. For instance, if high soil moisture is present, the decision may be taken not to apply a treatment product due to sweeping effects.

In a further embodiment, the weather data, current or expected, and/or the soil data, current or expected, may be provided to a growth stage model to further determine the growth stage of a plantation, a weed or a crop plant. Additionally, or alternatively the weather data and the soil data may be provided to a disease model. Based on such data the determination of a configuration of the treatment device, in particular parts of the treatment arrangement like single nozzles, for application is enhanced, since the efficacy impact on the treatment product as e.g. the weeds and crops will grow with different speed during the time and after application may be included into the activation decision and dosage. Thus e.g. the size of the weed or the infection phase of the pathogen (either seen or derived from infection event in models) at the moment of application may be included into the activation decision and dosage.

Thus, the efficiency of the treatment and/or the efficacy of the treatment product can be improved. Thus, an improved method for plantation treatment of a plantation field improving economic return of investment and improving an impact into the ecosystem is provided.

In a preferred embodiment, the method comprises the steps:
Determining or providing validation data dependent on a performance review of the treatment of the plantation; and
adjusting the parametrization and/or the at least one treatment product composition dependent on the validation data.

Validation data may be at least in part spatially resolved for the plantation field. Validation data can for instance be measured in specific locations of the plantation field.

Preferably, the performance review comprises a manual control of the parametrization and/or the at least one treatment product composition and/or an automated control of the parametrization and/or the at least one treatment product composition. For example, the manual control relates to a farmer observing the plantation field and answering a questionnaire. In a further example, the performance review is executed by taking images of a part of the plantation field that already has been treated and analyzing the taken images. In other words, the performance review evaluates the efficiency of the treatment and/or the efficacy of the treatment product after a plantation has been treated. For example, if a weed that has been treated is still present although it has been treated, the performance review will include information stating that the parametrization and/or the at least one treatment product composition used for this treatment did not achieve the goal of killing the weed.

Thus, the efficiency of the treatment and/or the efficacy of the treatment product can be improved. Thus, an improved method for plantation treatment of a plantation field improving economic return of investment and improving an impact into the ecosystem is provided.

In a preferred embodiment, the method comprises:
adjusting the parametrization and/or the at least one treatment product composition using a machine learning algorithm.

The machine learning algorithm may comprise decision trees, naive bayes classifications, nearest neighbors, neural networks, convolutional or recurrent neural networks, generative adversarial networks, support vector machines, linear regression, logistic regression, random forest and/or gradient boosting algorithms. Preferably the result of a machine learning algorithm is used to adjust the parametrization.

Preferably the machine learning algorithm is organized to process an input having a high dimensionality into an output of a much lower dimensionality. Such a machine learning algorithm is termed “intelligent” because it is capable of being “trained.” The algorithm may be trained using records of training data. A record of training data comprises training input data and corresponding training output data. The training output data of a record of training data is the result that is expected to be produced by the machine learning algorithm when being given the training input data of the same record of training data as input. The deviation between this expected result and the actual result produced by the algorithm is observed and rated by means of a “loss function”. This loss function is used as a feedback for adjusting the parameters of the internal processing chain of the machine learning algorithm. For example, the parameters may be adjusted with the optimization goal of minimizing the values of the loss function that result when all training input data is fed into the machine learning algorithm and the outcome is compared with the corresponding training output data. The result of this training is that given a relatively small number of records of training data as “ground truth”, the machine learning algorithm is enabled to perform its job well for a number of records of input data that higher by many orders of magnitude.

Thus, the efficiency of the treatment and/or the efficacy of the treatment product can be improved. Thus, an improved method for plantation treatment of a plantation field improving economic return of investment and improving an impact into the ecosystem is provided.

According to a further aspect a field manager system for a treatment device for plantation treatment of a plantation field comprises an offline field data interface being adapted for receiving offline field data relating to expected conditions on the plantation field, a validation data interface being adapted for receiving validation data, a machine learning unit being adapted determining the parametrization of the treatment device dependent on the offline field data and being adapted for adjusting the parametrization dependent on the validation data and a parametrization interface being adapted for providing the parametrization to a treatment device, as described herein.

In a preferred embodiment, the method comprises:
determining a parametrization comprises determining a tank recipe for a treatment product tank of the treatment device.

Preferably, the tank recipe comprises the absolute or relative amount of different components of plantation treatment product, suitable for the plantation field to be treated.

According to a further aspect, a field manager system for a treatment device for plantation treatment of a plantation field, comprises an offline field data interface being adapted for receiving offline field data relating to expected conditions on the plantation field, thereby determining at least one treatment product composition expected to be used for treating the plantation, a machine learning unit being adapted determining the parametrization of the treatment device dependent on the offline field data and a parametrization interface, being adapted for providing the parametrization to a treatment device, as described herein.

In a preferred embodiment, the field manager system comprises a validation data interface being adapted for receiving validation data, wherein the machine learning unit is adapted for adjusting the parametrization dependent on the validation data. Validation data may be at least in part spatially resolved for the plantation field. Validation data can for instance be measured in specific locations of the plantation field.

In a preferred embodiment, the machine learning unit is adapted for determining a parametrization by a machine learning algorithm based on the taken image and the online field data.

According to a further aspect, a treatment device for plantation treatment of a plant, comprises an image capture device being adapted for taking an image of a plantation, a parametrization interface being adapted for receiving a parametrization from a field manager system, as described herein, a treatment arrangement being adapted for treating the plantation dependent on the received parametrization, an image recognition unit being adapted for recognizing objects on the taken image, a treatment control unit being adapted for determining a treatment product composition optionally dependent or based on the determined parametrization, online field data and/or the recognized objects and the recognized objects and adapted for determining a control signal for controlling a treatment arrangement of the treatment device based on the determined parametrization, the recognized objects and the determined treatment product composition, wherein the parametrization interface of the treatment device is connectable to a parametrization interface of a field manager system, as described herein, wherein the treatment device is adapted to activate the treatment arrangement based on the control signal of the treatment control unit.

In a preferred embodiment, the treatment device comprises an online field data interface being adapted for receiving online field data relating to current conditions on the plantation field, wherein the treatment control unit controlling a treatment arrangement of the treatment device based on the determined parametrization, the recognized objects and the determined treatment product composition and/or the online field data.

In a preferred embodiment, the image capture device comprises one or a plurality of cameras, in particular on a boom of the treatment device, wherein the image recognition unit is adapted for recognizing objects, e.g. weeds, insects, pathogens and/or plantation using e.g. red-green-blue RGB data and/or near infrared NIR data.

In a preferred embodiment, the treatment device, as described herein, further comprises a controlling device, as described herein.

In a preferred embodiment, the treatment device is designed as a smart sprayer, wherein the treatment arrangement is a nozzle arrangement.

The nozzle arrangement preferably comprises several independent nozzles, which may be controlled independently.

According to a further aspect, a treatment system comprises a filed manager system, as described herein, and a treatment device, as described herein.

Advantageously, the benefits provided by any of the above aspects equally apply to all of the other aspects and vice versa. The above aspects and examples will become apparent from and be elucidated with reference to the embodiments described hereinafter.

### BRIEF DESCRIPTION OF THE DRAWINGS

Exemplary embodiments will be described in the following with reference to the following drawings:

FIG. 1 shows a schematic diagram of a plantation treatment system;

FIG. 2 shows a flow diagram of a plantation treatment method;

FIG. 3 shows a schematic view of a zone map of a plantation field;

FIG. 4 shows a schematic view of a treatment device on a plantation field; and

FIG. 5 shows a schematic view of an image with detected objects.

### DETAILED DESCRIPTION OF EMBODIMENTS

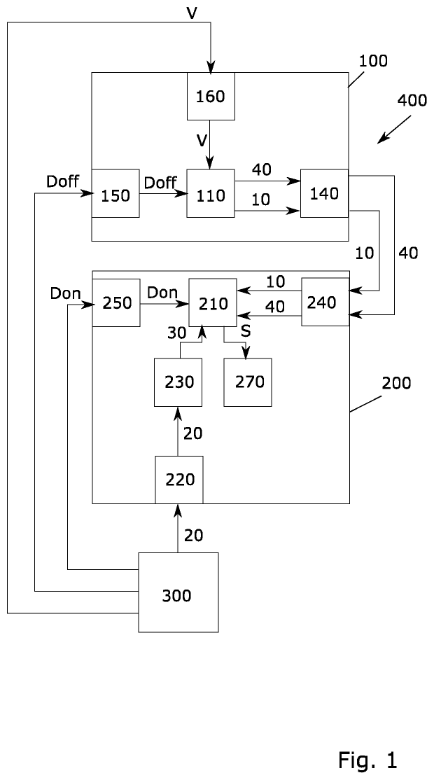

FIG. 1 shows a plantation treatment system 400 for treating a plantation of a plantation field 300 by at least one treatment device 200 controlled by a field manager system 100.

The treatment device 200, preferably a smart sprayer, comprises a treatment control unit 210, an image capture device 220, an image recognition unit 230 and a treatment arrangement 270 as well as a parametrization interface 240 and an online field data interface 250.

The image capture device 220 comprises at least one camera, configured to take an image 20 of a plantation field 300. The taken image 20 is provided to the image recognition unit 230 of the treatment device 200.

The field manager system 100 comprises a machine learning unit 110. Additionally, the field manager system 100 comprises an offline field data interface 150, a parametrization interface 140 and a validation data interface 160. The field manager system 100 may refer to a data processing element such as a microprocessor, microcontroller, field programmable gate array (FPGA), central processing unit (CPU), digital signal processor (DSP) capable of receiving field data, e.g. via a universal service bus (USB), a physical cable, Bluetooth, or another form of data connection. The field manager system 100 may be provided for each treatment device 200. Alternatively, the field manager system may be a central field manager system, e.g. a cloud computing environment or a personal computer (PC), for controlling multiple treatment devices 200 in the field 300.

The field manager system 100 is provided with offline field data Doff relating to expected condition data of the plantation field 300. Preferably, the offline field data Doff comprises local yield expectation data, resistance data relating to a likelihood of resistance of the plantation against a treatment product, expected weather condition data, expected plantation growth data, zone information data, relating to different zones of the plantation field, expected soil data, e.g. soil moisture data, and/or legal restriction data.

The offline field data Doff is provided from external repositories. For example, the expected weather data may be based on satellite data or measured weather data used for forecasting the weather. The expected plantation growth data is for example provided by a database having stored different plantation growth stages or from plantation growth stage models, which make statements on the expected growth stage of a crop plant, a weed and/or a pathogen dependent on past field condition data. The expected plantation growth data may be provided by plantation models, which are basically digital twins of the respective plantation, and estimate the growth stage of the plantation, in particular dependent on former field data. Further, for example the expected soil moisture data may be determined dependent on the past, present and expected weather condition data. The offline field data Doff may also be provided by an external service provider.

Dependent on the offline field data Doff, the machine learning unit 110 determines a parametrization 10. Preferably, the machine learning unit 110 knows the planned time of treatment of the plantation. For example, a farmer provides the field manager system 100 with the information that he plans to treat the plantation in a certain field the next day. The parametrization 10 preferably is represented as a configuration file that is provided to the parametrization interface 140 of the field manager system 100. Ideally, the parametrization 10 is determined by the machine learning unit 110 on the same day, the treatment device 200 is using the parametrization 10. Here the machine learning unit 110 may include trained machine learning algorithm(s), wherein the output of the machine learning algorithm(s) may be used for the parametrization. The determination of the parametrization may also be conducted without involvement of any machine learning algorithm(s). Via the parametrization interface 140, the parametrization 10 is provided to the treatment device 200, in particular the parametrization interface 240 of the treatment device 200. For example, the parametrization 10 in form of a configuration file is transferred and stored in a memory of the treatment device 200.

Additionally, the machine learning unit determines at least a treatment product composition 40 expected to be used for treating the plantation in the field 300. The determination is made in view of the whole plantation field 300 or at least the part of the plantation field 300 that is planned to be treated. The at least one product composition 40 relates to different herbicides, pathogen and/or insecticides as well as mixing solutions like water or nutrient solutions like nitrogen solutions for mixing with the treatment product. For example, the machine learning unit knows from determines a first active ingredient AI1 and a second active ingredient AI2, which both are different herbicides. The treatment product composition 40 preferably is represented as part of the parametrization in a configuration file that is provided to the parametrization interface 140 of the field manager system 100. Ideally, the treatment product composition 40 is determined by the machine learning unit 110 on the same day, the treatment device 200 is using the treatment product composition 40. Via the parametrization interface 140, the treatment product composition 40 is provided to the treatment device 200, in particular the parametrization interface 240 of the treatment device 200. For example, the treatment product composition 40 in form of a configuration file is uploaded to a memory of the treatment device 200.

When the parametrization 10 including the treatment product composition 40 are received by the treatment device 200, in particular the treatment control unit 210, the treatment of plantation in the plantation field 300 can begin. Ideally, the user, in particular a farmer, is additionally provided with a tank recipe by the filed manager 100. The tank recipe is determined dependent on the parametrization 10 including the determined treatment product compositions 40. Thus, the farmer knows approximately how much treatment product of which treatment product composition 40 is needed to treat the plantation in the plantation field 300.

The treatment device 200 moves around the plantation field 300 and detects and recognizes objects 30, in particular crop plants, weeds, pathogens and/or insects on the plantation field 300.

Therefore, the image capture device 200 constantly takes images 20 of the plantation field 300. The images 20 are provided to the image recognition unit 230, which runs an image analysis on the image 20 and detects and/or recognizes objects 30 on the image 20. The objects 30 to detect are preferably crops, weeds, pathogens and/or insects. Recognizing objects includes recognizing a plantation, preferably a type of plantation and/or a plantation size, an insect, preferably a type of insect and/or an insect size, and/or a pathogen, preferably a type of pathogen and/or a pathogen size. For example, it is recognized the difference between for example Amaranthus retroflexus and Digitaria sanguinalis, or between a bee and a locust. The objects 30 are provided to the treatment control unit 210.

The treatment control unit 210 was provided with the parametrization 10 including the treatment product composition(s), the first active ingredient AI1 and the second active ingredient AI2, in form of the configuration file. The parametrization 10 can be illustrated as a decision tree, wherein based on input data, over different layers of decisions a treatment of a plantation is decided and optionally the dose and composition of the treatment product is decided. For example, in a first step, it is checked, if the biomass of the detected weed exceeds a predetermined threshold set up by the parametrization 10. The biomass of the weed generally relates to the degree of coverage of the weed in the taken image 20. For example, if the biomass of the weed is below 4%, it is decided that the weed is not treated at all. If the biomass of the weed is above 4%, further decisions are made. For example, in a second step, if the biomass of the weed is above 4%, dependent on the moisture of the soil it is decided, if the weed is treated. If the moisture of the soil exceeds a predetermined threshold, it is still decided to treat the weed and otherwise it is decided not to treat the weed. This is, because the herbicides used to treat the weed may be more effective, when the weed is in a growth phase, which is triggered by a high soil moisture. The parametrization 10 already includes information about the expected soil moisture. Since it has been raining the past days, the expected soil moisture is above the predetermined threshold and it will be decided to treat the weed. However, the treatment control unit 210 also is provided by online field data Don, in this case from a soil moisture sensor, providing the treatment control unit 210 with additional data. The decision tree of the configuration file will therefore be decided based on the online field data Don. In an exemplary embodiment, the online field data Don comprises the information that the soil moisture is below the predetermined threshold. Thus, it is decided not to treat the weed.

The treatment control unit 210 generates a treatment control signal S based on the parametrization 10, the recognized objects and/or the online field data Don. The treatment control signal S therefore contains information if the recognized object 20 should be treated or not. The treatment control unit 210 then provides the treatment control signal S to the treatment arrangement 270, which treats the plantation based on the control signal S. The treatment arrangement 270 comprises in particular a chemical spot spray gun with different nozzles, which enables it to spray an herbicide, insecticide and/or fungicide with high precision.

Thus, a parametrization 10 is provided dependent on offline field data Doff relating to an expected field condition. Based on the parametrization 10 a treatment device 200 can decide, which plantation should be treated only based on the situationally recognized objects in the field. Thus, the efficiency of the treatment and/or the efficacy of the treatment product can be improved. In order to further improve the efficiency of the treatment and/or the efficacy of the treatment product online field data Don can be used to include current measurable conditions of the plantation field.

The provided treatment arrangement 400 additionally is capable of learning. The machine learning unit 110 determines the parametrization 10 dependent on a given heuristic. After the plantation treatment based on the provided parametrization 10, it is possible to validate the efficiency of the treatment and the efficacy of the treatment product. For example, the farmer can provide the field manager system 100 with field data of a part of the plantation field that has been treated before based on the parametrization 10. This information is referred to as validation data V. The validation data V is provided to the field manager system 100 via the validation data interface 160, providing the validation data V to the machine learning unit 110. The machine learning unit 110 then adjusts the parametrization 10 or the heuristic, which is used to determine the parametrization 10 according to the validation data V. For example, the validation data V indicates that the weed that has been treated based on the parametrization 10 is not killed, the adjusted parametrization 10 lowers the threshold to treat the plantation in one of the branches of the underlying decision tree.

As an alternative to the parametrization 10 and/or the treatment product composition 40 in form of a configuration file provided by an external field manager system 100 to a treatment device 200, the functionality of the field manager system 100 can also be embedded into the treatment device 200. For example, a treatment device with relatively high computational power is capable to integrate the field manager system 100 within the treatment device 200. Alternatively, the whole described functionality of the field manager system 100 and the functionality up to the determination of the control signal S by the treatment device 200 can be calculated externally of the treatment device 200, preferably via a cloud service. The treatment device 200 thus is only a “dumb” device treating the plantation dependent on a provided control signal S.

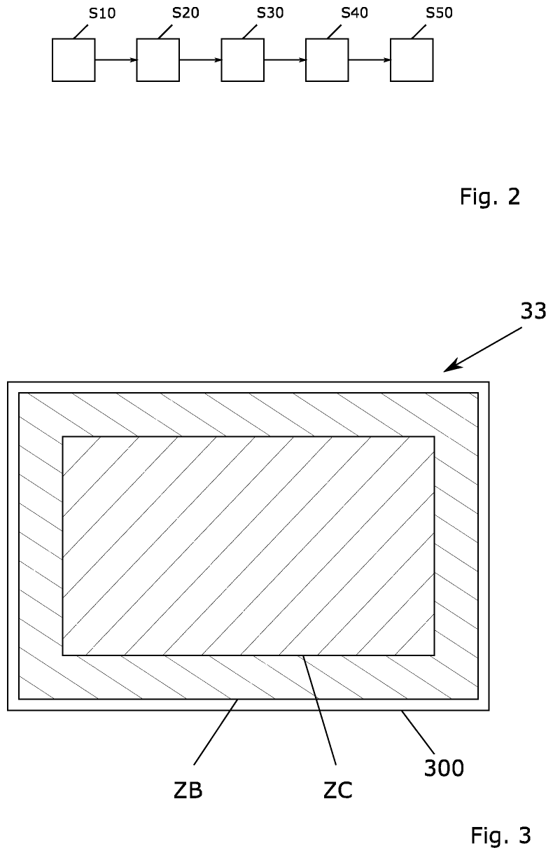

FIG. 2 shows a flow diagram of a plantation treatment method.

In step S10, a parametrization 10 for controlling a treatment device 200 is received by the treatment device 200 from a field manager system 100, wherein the parametrization 10 is dependent on offline field data Doff relating to expected conditions on the plantation field 300, and at least one treatment product composition 40 expected to be used for treating the plantation dependent on the parametrization 10 is received. In step S20, an image 20 of a plantation of a plantation field 300 is taken. In step S30, objects 30 on the taken image 20 are detected. In step S40, at least one of the at least one treatment product composition 40 is chosen for treating the plantation dependent on the determined parametrization 10 and the recognized objects 30. In step S50, a control signal S for controlling a treatment arrangement 270 of the treatment device 200 is determined based on the determined parametrization 10, the recognized objects 30 and the chosen treatment product composition 40.

FIG. 3 shows a zone map 33 of a plantation field 300. The zone map 33 divides the plantation field 300 in different zones ZB, ZC depending on a type of zone map 33. In this case, the zone map 33 divides the plantation field 300 in a center zone ZC and a border zone ZB. The border zone ZB extends around the edges of the plantation field 300. The border zone ZB is easy accessible for unauthorized persons and therefore underlies more strict legal restrictions than the center zone ZC. Based on the zone map 33, zone information is determined, indicating the special legal restrictions of the different zones ZB, ZC.

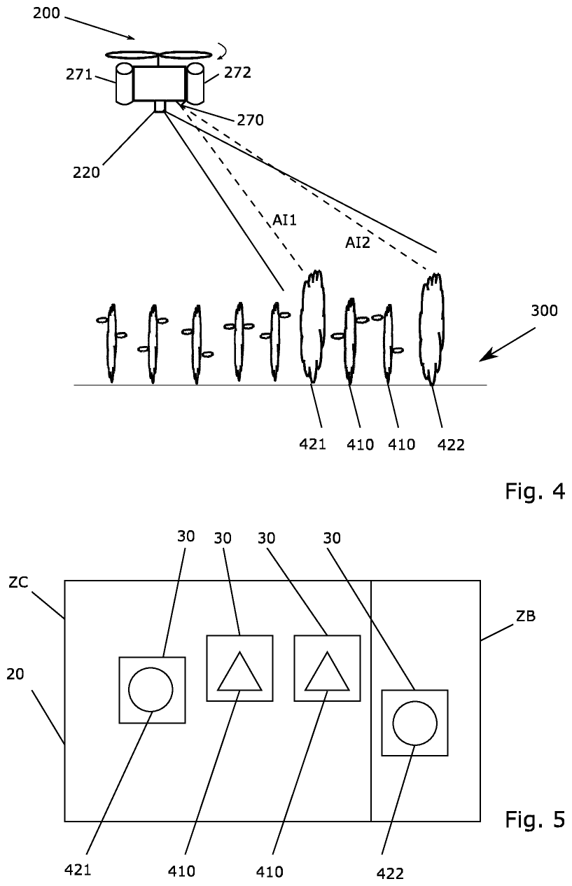

FIG. 4 shows a treatment device 200 in form of an unmanned aerial vehicle (UAV) flying over a plantation field 300 containing a crop 410. Between the crop 410 there are also a number of weeds 421, 422, The weed 421, 422 is particularly virulent, produces numerous seeds and can significantly affect the crop yield. This weed 421, 422 should not be tolerated in the plantation field 300 containing this crop 410.

The UAV 200 has an image capture device 220 comprising one or a plurality of cameras, and as it flies over the plantation field 300 imagery is acquired. The UAV 200 also has a GPS and inertial navigation system, which enables both the position of the UAV 200 to be determined and the orientation of the camera 220 also to be determined. From this information, the footprint of an image on the ground can be determined, such that particular parts in that image, such as the example of the type of crop, weed, insect and/or pathogen can be located with respect to absolute geospatial coordinates. The image data acquired by the image capture device 220 is transferred to an image recognition unit 120.

The image acquired by the image capture device 220 is at a resolution that enables one type of crop to be differentiated from another type of crop, and at a resolution that enables one type of weed to be differentiated from another type of weed, and at a resolution that enables not only insects to be detected but enables one type of insect to be differentiated from another type of insect, and at a resolution that enables one type of pathogen to be differentiated from another type of pathogen.

The image recognition unit 120 may be external from the UAV 200, but the UAV 200 itself may have the necessary processing power to detect and identify crops, weeds, insects and/or pathogens. The image recognition unit 120 processes the images, using a machine learning algorithm for example based on an artificial neural network that has been trained on numerous image examples of different types of crops, weeds, insects and/pathogens, to determine which object is present and also to determine the type of object.

The UAV also has a treatment arrangement 260, in particular a chemical spot spray gun with different nozzles, which enables it to spray an herbicide, insecticide and/or fungicide with high precision.

In order to treat the weed 421, 422, the UAV 200 is able to use two different treatment product compositions, a first active ingredient AI1 and a second active ingredient AI2. For example, the weeds 421, 422 are Amaranthus retroflexus and Digitaria sanguinalis, which are expected to be treated on the field. Both weeds are especially well treated with the first active ingredient AI1. The first active ingredient AI1 is cheaper and more efficient than the second active ingredient AI2 but also is considered more ecological harmful. The field manager system 100 provides the farmer with a tank recipe. In this case, the field 300 comprises a relatively big center zone ZC and a relatively small border zone ZB, as shown in FIG. 3. In view of the legal restrictions, the first active ingredient AI1 is more legally restricted than the second active ingredient AI2. In this case, this means that in the border zone ZB, the first active ingredient AI1 is legally not allowed to be used. Thus, the provided tank recipe indicates that the first active ingredient AI1, which usually can be used in the relatively big center zone ZC is needed in a larger amount than the second active ingredient AI2, which is allowed in the relatively small border zone ZB. The farmer then can equip the treatment device with the respective treatment products. The first active ingredient AI1 is stored in the first active ingredient tank 271 and the second active ingredient AI2 is stored in the second active ingredient tank 272. The treatment arrangement 270 is able to treat the plantation in the plantation field from the first active ingredient tank 271 and/or the second active ingredient tank 272.

As shown in FIG. 5, the image capture device 220 takes in image 20 of the field 300. The image recognition analysis detects four objects 30 and identifies two crops 410 (triangle), a first unwanted weed 421 (circle) and a second unwanted weed 422 (circle). Therefore, the UAV 200 is controlled to treat the unwanted weeds 421, 422. However, the first weeds 421 is arranged in the center zone ZC of the plantation field and the second weeds 422 is arranged in the buffer zone ZB of the plantation field. Based on the online field data Don, the taken image 20 and the treatment product composition, it is determined to treat the weeds 421, 422 with the cheaper and more efficient first active ingredient AI1. However, the first active ingredient AI1 is not allowed to be used in the border zone ZB. Therefore, the second weed 422 in the border zone ZB is to be determined to be treated by the second active ingredient AI2. Without the determination of different treatment products AI1, AI2, the UAV 200 only is able to treat the whole plantation field 300 with the second active ingredient AI2 in order to not violate the specific legal restrictions of the border zone ZB.

Thus, an improved method for plantation treatment of a plantation field improving economic return of investment and improving an impact into the ecosystem is provided.

### REFERENCE SIGNS

10 parametrization
20 image
30 objects on image
40 treatment product composition
100 field manager system
110 machine learning unit
140 parametrization interface
150 offline field data interface
160 validation data interface
200 treatment device (UAV)
210 treatment control unit
220 image capture device
230 image recognition unit
240 parametrization interface
250 online field data interface
270 treatment arrangement
271 first active ingredient tank
272 second active ingredient tank
300 plantation field
400 treatment system
410 crop
421 first weed
422 second weed
S treatment control signal
Don online field data
Doff offline field data
V validation data
ZC centre zone
ZB border zone
AI1 treatment product (first active ingredient)
AI2 treatment product (second active ingredient)
S10 receiving parametrization and treatment product composition
S20 taking image
S30 recognizing object
S40 choosing treatment product
S50 determining control signal

1. A method for plantation treatment of a plantation field with a treatment product, the method, the method comprising:
receiving (S10) a parametrization (10) for controlling a treatment device (200) by the treatment device (200) from a field manager system (100), wherein the parametrization (10) is dependent on offline field data (Doff) relating to expected conditions on the plantation field (300);
taking (S20) an image (20) of a plantation of a plantation field (300);
recognizing (S30) objects (30) on the taken image (20);
determining (S40) a treatment product composition optionally based on the determined parametrization, online field data and/or the recognized objects (30); and
determining (S50) a control signal (S) for controlling a treatment arrangement (270) of the treatment device (200) based on the determined parametrization (10), the recognized objects (30) and the determined treatment product composition (40).

2. The method of claim 1, wherein:
taking (S20) an image (20) of a plantation of a plantation field (300); recognizing (S30) objects (30) on the taken image (20); determining (S40) a treatment product composition; and determining (S50) a control signal (S) for controlling a treatment arrangement (270) are carried out as real time process, such that the treatment device (270) is instantaneous controllable based on taken images of the plantation field as the treatment device traverses through the field at the time of treatment in a specific location of the field.

3. The method of claim 1, further comprising:
receiving the offline field data (Doff) by the field manager system (100);
determining the parametrization (10) of the treatment device (200) dependent on the offline field data (Doff); and
providing the determined parametrization (10) to the treatment device (200).

4. The method of claim 1, wherein
determining the control signal (S) includes generating a tank actuator signal and a treatment arrangement signal to control release of the determined treatment product composition.

5. The method of claim 4, wherein:
the treatment device includes a treatment arrangement with more than one nozzle, and the treatment arrangement signal triggers one or more nozzles separately.

6. The method of claim 1, wherein:
the control signal is provided to a control unit of the treatment device to initiate treatment of the plantation field, wherein the control signal is configured to change the treatment product composition or at least one active ingredient of the treatment product composition during field treatment.

7. The method of claim 1, wherein
recognizing (S20) objects (20) includes recognizing a plantation, preferably a type of plantation and/or a plantation size, an insect, preferably a type of insect and/or an insect size, and/or a pathogen, preferably a type of pathogen and/or a pathogen size.

8. The method of claim 1, further comprising:
receiving online field data (Don) by the treatment device (200) relating to current conditions on the plantation field (300); and
determining the control signal (S) dependent on the determined parametrization (10), the determined treatment product composition (40) and the determined recognized objects (30) and/or the determined online field data (Don).

9. The method of claim 8, wherein:
the online field data (Don) relates to current weather condition data, current plantation growth data and/or current soil moisture data.

10. The method of claim 1, further comprising:
providing validation data (V) dependent on a performance review of the treatment of the plantation; and
adjusting the parametrization (10) dependent on the validation data (V).

11. The method of claim 1, further comprising:
adjusting the parametrization (10) using a machine learning algorithm.

12. The method of claim 1, wherein:
determining a parametrization (10) comprises determining a tank recipe for a treatment product tank of the treatment device (200).

13. (canceled)

14. (canceled)

15. A treatment device (200) for plantation treatment of a plantation, the treatment device (200) comprising:
an image capture device (220) being adapted for taking an image (20) of a plantation;
a parametrization interface (240) being adapted for receiving a parametrization (10) from a field manager system (100);
a treatment arrangement (270) being adapted for treating the plantation dependent on the received parametrization (10);
an image recognition unit (230) being adapted for recognizing objects (30) on the taken image (20); and
a treatment control unit (210) being adapted for determining (S40) a treatment product composition (40) optionally based on the determined parametrization (10), online field data and/or the recognized objects (30); and adapted for determining a control signal (S) for controlling a treatment arrangement (240) of the treatment device (200) based on the determined parametrization (10), the recognized objects (30) and the determined treatment product composition (40);
wherein the parametrization interface (240) of the treatment device (200) is connectable to a parametrization interface (140) of the field manager system (100);
wherein the treatment device (200) is adapted to activate the treatment arrangement (270) based on the control signal (S) of the treatment control unit (210).

16. The treatment device (200) of claim 15, further comprising:
an online field data interface (240) being adapted for receiving online field data (Don) relating to current conditions on the plantation field (300); wherein
the treatment control unit controlling a treatment arrangement (240) of the treatment device (200) based on the determined parametrization (10), the recognized objects (30) and the determined treatment product composition (40) and/or the online field data.

17. The treatment device of claim 15,
wherein the image capture device (220) comprises one or a plurality of cameras, in particular on a boom of the treatment device (200), wherein the image recognition unit (230) is adapted for recognizing insects, weed and/or plantation using red-green-blue RGB data and/or near infrared NIR data.

18. The treatment device of claim 15,
wherein the treatment device (200) is designed as a smart sprayer, wherein the treatment arrangement (270) is a nozzle arrangement.

19. The treatment device of claim 15,
wherein the image capture device (220) comprises a plurality of cameras and the treatment arrangement (270) comprises a plurality of nozzle arrangements, each being associated to one of the plurality of cameras, such that images captured by the cameras are associated with the area to be treated by the respective nozzle arrangement.

20. A treatment system comprising the treatment device according to claim 15.

21. A field manager system (100) for a treatment device (200) for treatment of a plantation field (300), the field manager system (100) comprising:
an offline field data interface (150) being adapted for receiving offline field data (Doff) relating to expected conditions on the plantation field (300);
a machine learning unit (110) being adapted determining parametrization (10) of the treatment device (200) dependent on the offline field data (Doff); and
a parametrization interface (140), being adapted for providing the parametrization (10) to a treatment device (200) according to claim 14.

22. The field manager system (100) of claim 21, further comprising:
a validation data interface (160) being adapted for receiving validation data (V); wherein
the machine learning unit (110) is adapted for adjusting the parametrization (10) dependent on the validation data (V).
